(19) United States
(12) Patent Application Publication
(10) Pub. No.: US 2013/0290736 A1
(43) Pub. Date: Oct. 31, 2013

(54) DATA STORAGE DEVICE, DATA CONTROL DEVICE AND METHOD FOR ENCRYPTING DATA

(71) Applicant: KABUSHIKI KAISHA TOSHIBA, Tokyo (JP)

(72) Inventors: Yoshiyuki Kudoh, Kawasaki-Shi (JP); Teruji Yamakawa, Tokyo (JP)

(21) Appl. No.: 13/899,454

(22) Filed: May 21, 2013

Related U.S. Application Data
(63) Continuation of application No. 13/252,076, filed on Oct. 3, 2011, now abandoned.

(30) Foreign Application Priority Data
Nov. 26, 2010 (JP) 2010-263381

(51) Int. Cl. G06F 21/60

(52) U.S. Cl. CPC G06F 21/602
USPC 713/189

(57) ABSTRACT

According to one embodiment, a data storage device includes an encryption module, a write module, and a controller. The encryption module encrypts or decrypts data. The write module writes, on a storage medium, encrypted data of data received from a host, the encrypted data being encrypted by the encrypting module. The controller causes the encryption module to encrypt data received from a host and to transfer the encrypted data to the write module through a buffer memory, during normal encryption process, and to re-encrypt the data recorded on the storage medium, during re-encryption process. During the re-encryption process, the controller causes the encryption module to decrypt the encrypted data read from the storage medium, to store the decrypted data into the buffer memory, and to re-encrypt the decrypted data from the buffer memory by the encryption module and to transfer the re-encrypted data to the write module.

### CROSS-REFERENCE TO RELATED APPLICATIONS

This application is a continuation of U.S. patent application Ser. No. 13/252,076, filed Oct. 3, 2011, which is based upon and claims the benefit of priority from Japanese Patent Application No. 2010-263381, filed Nov. 26, 2010, the entire contents of each of which are incorporated herein by reference.

### FIELD

Embodiments described herein relate generally to a data storage device having a function of encrypting data, a data control device and a method for encrypting data.

### BACKGROUND

Data storage devices are available, representative examples of which, are a hard disk drive (HDD) and a solid state drive (SSD). A data storage device has been proposed, which has a function of encrypting data (user data) which is recorded on a storage medium. The storage medium is a disk for use in HDDs or a flash memory for use in SSDs.

In such a data storage device, encrypted data is recorded on the storage medium. Hence, the data recorded on the recording medium can be protected, thus ensuring the data security, even if the storage device is discarded or the storage medium is removed from the storage device.

In any data storage device that has the function of encrypting data, it is desired that the encryption key be updated at regular intervals to protect the data recorded in the storage medium. In order to update the encryption key, however, an re-encryption process must be performed, in which all data recorded in the storage medium are first decrypted with the encryption key not updated and are then encrypted with the encryption key updated (new encryption key).

The larger the amount of data recorded in the storage medium, the longer is the time required to perform this re-encryption process. For example, several hours are required. Further, the data storage device needs to receive a data access (read/write access) from a host, while it is re-encrypting the data. Consequently, the operating efficiency of the data storage device may decrease if the re-encryption process is performed in order to update the encryption key at regular intervals.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing the major components of a data storage device according to an embodiment;

FIG. 2 is a block diagram explaining the input/output configuration of the encryption module according to the embodiment;

FIG. 3 is a flowchart explaining a normal operation of the data storage device according to the embodiment;

FIG. 4 is a flowchart explaining the sequence of the re-encryption process according to the embodiment; and

FIG. 5 is a flowchart explaining the sequence of accessing data in the re-encryption process according to the embodiment.

### DETAILED DESCRIPTION

Various embodiments will be described hereinafter with reference to the accompanying drawings.

In general, according to one embodiment, a data storage device includes an encryption module, a write module, and a controller. The encryption module is configured to encrypt or decrypt data. The write module is configured to write, on a storage medium, encrypted data of data received from a host, the encrypted data being encrypted by the encrypting module. The controller is configured to cause the encryption module to encrypt data received from a host and to transfer the encrypted data to the write module through a buffer memory, during normal encryption process, and to re-encrypt the data recorded on the storage medium, during re-encryption process. During the re-encryption process, the controller is configured to cause the encryption module to decrypt the encrypted data read from the storage medium, to store the decrypted data into the buffer memory, and to re-encrypt the decrypted data from the buffer memory by the encryption module and to transfer the re-encrypted data to the write module.

[Configuration of the Data Storage Device]

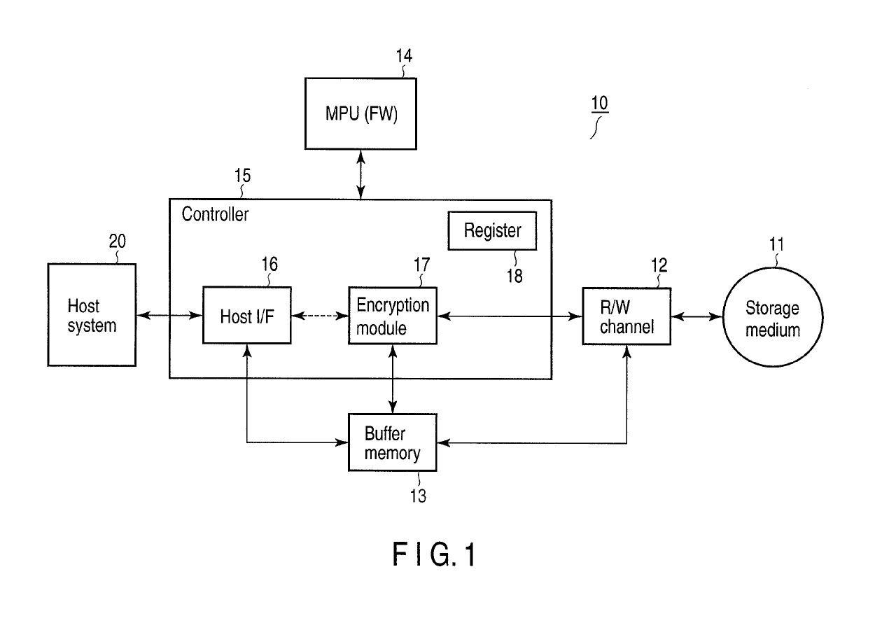

FIG. 1 is a block diagram showing the major components of a data storage device 10 according to an embodiment.

The data storage device 10 is a hard disk drive (HDD). Instead, the device 10 may be a solid state drive (SSD).

As shown in FIG. 1, the data storage device 10 has a storage medium 11, a read/write (R/W) channel 12, a buffer memory 13, a microprocessor (MPU) 14, and a controller 15.

The storage medium 11 is a disk, because the data storage device 10 is an HDD. If the data storage device 10 is an SSD, the storage medium 11 is a flash memory. Note that the embodiment incorporates a read/write mechanism (not shown) that includes a head configured to write and read data on and from the storage medium 11.

The R/W channel 12 processes a signal to record data in the storage medium 11 or reproduce data from the storage medium 11. That is, the R/W channel 12 generates a write signal representing the data (encrypted data) transmitted from the controller 15, which should be written on the storage medium 11. The R/W channel 12 further reproduces data from the read signal read from the storage medium 11. If the data storage device 10 is an SSD, the R/W channel 12 is a memory controller configured to control the flash memory.

The MPU 14 cooperates with the controller 15 to control the other components of the data storage device 10, in accordance with firm ware (FW). In this embodiment, the MPU 14 sets a normal operating mode or a re-encrypting mode, sets an encrypting mode or a decrypting mode, and sets an encryption key.

The controller 15 controls the buffer memory 13, ultimately controlling the data transfer between a host system (hereinafter referred to as “host”) 20 and the storage medium 11. The host 20 is, for example, a personal computer and the CPU incorporated in a digital device. The controller 15 has a host interface (host I/F) 16, an encryption module 17, and a register 18.

The host I/F 16 is the interface that achieves data transfer between the host 20 and the data storage device 10. The encryption module 17 uses an encryption key (encryption/decryption key data) set in the register 18, encrypting the data (write data) transmitted from the host 20. The encryption module 17 further decrypts the data (encrypted data) read from the storage medium 11 and reproduced by the R/W channel 12.

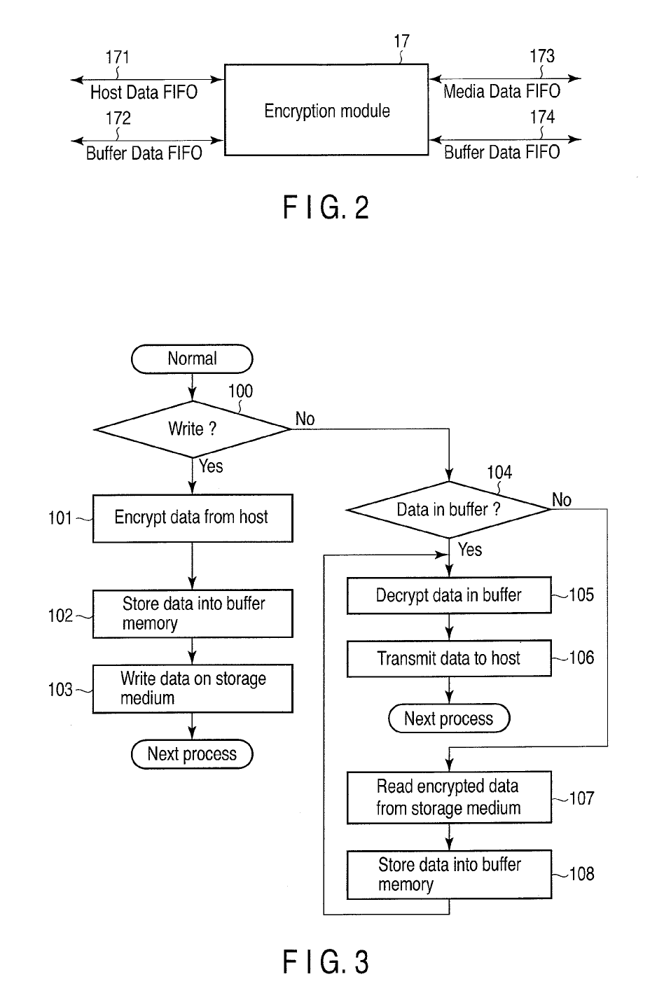

FIG. 2 is a diagram explaining the input/output configuration of the encryption module 17 used in this embodiment. As shown in FIG. 2, the encryption module 17 has first to fourth input/output units 171 to 174 of first-in, first-out (FIFO) type.

The first input/output unit 171 inputs and outputs data (also called “host data”) to and from the host I/F 16 in the normal operating mode. The host data is data the data storage device 10 transmits to, or receives from, the host 20, and corresponds to the write data received from the host 20 or the decrypted data that should be transmitted to the host 20. The second input/output unit 172 inputs and outputs data (also called “buffer data”) to and from the buffer memory 13 in the normal operating mode. The third input/output unit 173 inputs and outputs data (also called “media data”) to and from the R/W channel 12 in the re-encrypting mode. The fourth input/output unit 174 inputs and outputs data (buffer data) to and from the buffer memory 13 in the re-encrypting mode.

[Re-Encrypting Process]

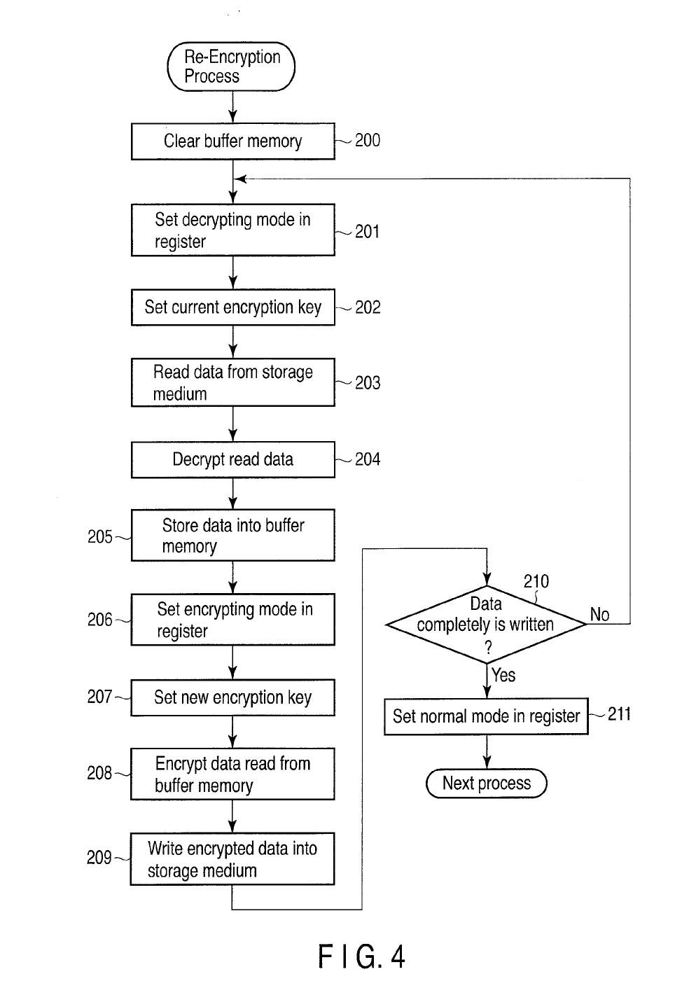

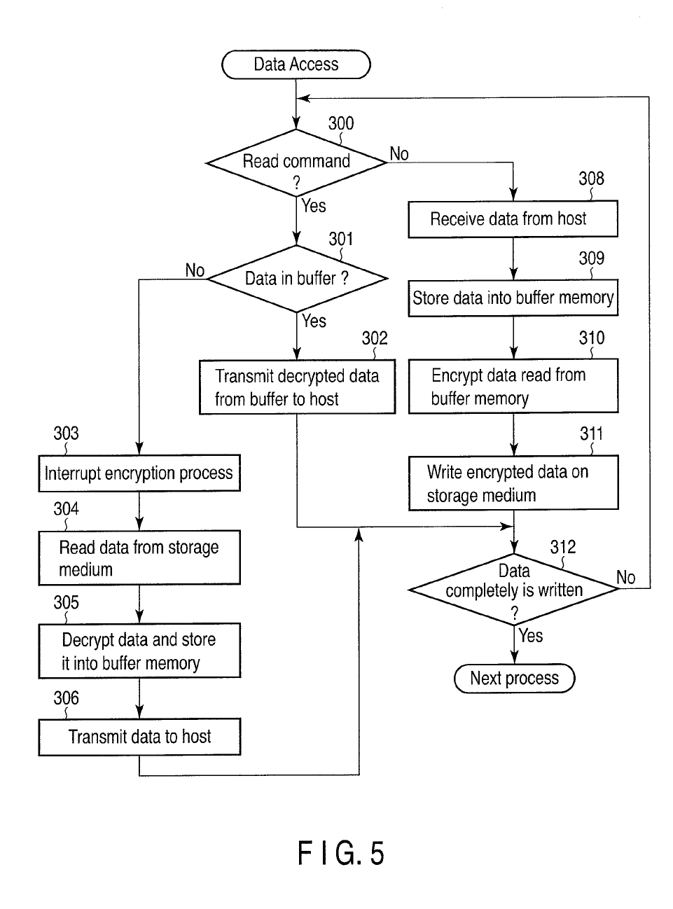

How the data storage device 10 operates in the normal operating mode and the re-encrypting mode will be explained with reference to the flowcharts of FIG. 3, FIG. 4 and FIG. 5.

First, how the data storage device 10 operates in the normal operating mode will be explained with reference to the flowchart of FIG. 3. The normal operating mode is an operating mode equivalent to an ordinary read/write operation or an ordinary command processing.

On receiving a write command from the host 20, the host I/F 16 transfers data (write data) to the encryption module 17 (YES in Block 100). Note that the register 18 stores an encryption key (called “current encryption key” for convenience) the MPU 14 has set.

The encryption module 17 receives the data (host data) transferred from the host I/F 16 through the first input/output unit 171 and encrypts the data, by using the encryption key set in the register 18 (Block 101). More precisely, the encryption module 17 encrypts the host data in units of logic block addresses. The encryption module 17 outputs encrypted data, which is stored through the second input/output unit 172 into the buffer memory 13 (Block 102).

In this embodiment, the data (host data) transmitted to, or received from, the host 20 is plain data, not such encrypted data as recorded on the storage medium 11. In some cases, however, the host 20 may transmits encrypted data to the data storage device 10. In view of this, the data shall be hereinafter referred to as “decrypted data” or “data,” not “plain data.”

The controller 15 transfers the encrypted data stored in the buffer memory 13 to the R/W channel 12. The R/W channel 12 converts the encrypted data to a write signal. The write signal is output to the read/write mechanism (not shown). The read/write mechanism writes the encrypted data on the storage medium 11 (Block 103).

When the host I/F 16 receives a read command, not a write command, from the host 20 (NO in Block 100), the controller 15 determines whether the buffer memory 13 stores the data (encrypted data) to be read (Block 104). If the buffer memory 13 stores this data (YES in Block 104), the encryption module 17 decrypts the data stored in the buffer memory 13, by using the encryption key set in the register 18 (Block 105). The host I/F 16 transmits the data, thus decrypted, to the host 20 (Block 106).

If the buffer memory 13 does not store the data to be read (NO in Block 104), the controller 15 causes the read/write mechanism (not shown) to read the data from the storage medium (Block 107). Then, the controller 15 stores the encrypted data read from the storage medium 11 into the buffer memory 13 (Block 108). The encryption module 17 decrypts the decrypted data stored in the buffer memory 13, by using the encryption key set in the register 18 (Block 105). The host I/F 16 transmits the data, thus decrypted, to the host 20 (Block 106).

Thus, in the normal operating mode, the data transferred from the host 20 is encrypted in units of logic blocks, irrespective of the physical positions on the storage medium 11. This achieves a high-speed command processing.

How the data storage device 10 performs the re-encryption process will be explained with reference to the flowcharts of FIG. 4 and FIG. 5.

The re-encryption process starts when the MPU 14 sets the re-encrypting mode in the register 18. More specifically, the MPU 14 sets the re-encrypting mode at regular intervals or in response to the instructions coming from the host 20. Before staring the re-encryption process in the re-encrypting mode set in the register 18, the controller 15 clears the buffer memory 13 (or erase the data in the buffer memory 13) (Block 200). This prevents the buffer memory 13 from storing both the encrypted data to be re-encrypted and the encrypted data generated in the re-encryption process (i.e., re-encrypted data).

The MPU 14 sets the decrypting mode for the re-encryption process, in the register 18 (Block 201). Further, the MPU 14 sets the current encryption key (i.e., encryption key used in the encryption process undergoing at present (Block 202). The controller 15 causes the read/write mechanism (not shown) to read the data (encrypted data) from the storage medium 11 (Block 203).

The encryption module 17 decrypts the encrypted data read from the storage medium 11, by using the current encryption key set in the register 18 (Block 204). The controller 15 stores the data decrypted by the encryption module 17, into the buffer memory 13 (Block 205).

Next, the MPU 14 sets the encryption mode for re-encryption process in the register 18 (Block 206). Further, the MPU 14 sets, in the register 18, a new encryption key for use in the re-encryption process (i.e., encryption key different from the current encryption key) (Block 207). The controller 15 sets the decrypted data stored in the buffer memory 13, in the encryption module 17.

The encryption module 17 uses the new encryption key set in the register 18, re-encrypting the decrypted data supplied from the buffer memory 13 (Block 208). The controller 15 causes the read/write mechanism (not shown) to write the re-encrypted data (written back) on the storage medium 11 (Block 209).

The MPU 14 repeats the sequence of the processes until all data recorded on the storage medium 11 is re-encrypted (Block 210). When the re-encryption process is completed, the MPU 14 sets the normal operating mode (i.e., normal read/write mode) in the register 18 (Block 211).

In the re-encryption process, the encryption module 17 does not use the second input/output unit 172, but uses the fourth input/output unit 174 that is, so to speak, input/output unit dedicated to the re-encryption process. The fourth input/output unit 174 inputs and outputs data (buffer data) to and from the buffer memory 13 in the re-encrypting mode. As a result, a path can be provided, which transfers data via the host I/F 16, encryption module 17 and buffer memory 13, as is shown in FIG. 1.

How data is accessed if the host 20 issues a normal read/write command during the re-encryption process will be explained with reference to the flowchart of FIG. 5.

If the host 20 issues a write command during the re-encryption process (NO in Block 300), the host I/F 16 receives the write command and the write data from the host 20 (Block 308). The controller 15 stores the write data received at the host I/F 16, into the buffer memory 13 (Block 309). That is, the controller 15 stores the write data into the buffer module 13, without causing the encryption module 17 to perform the encryption process. Therefore, the encryption module 17 can receive the write data transmitted from the host 20, without interrupting the re-encryption process.

The encryption module 17 uses the new encryption key set in the register 18, continuing the re-encryption process on the decrypted data stored in the buffer memory 13. The encryption module 17 also encrypts the write data transmitted from the host 20 and stored in the buffer memory 13, by using the new encryption key (Block 310).

The controller 15 causes the R/W channel 12 and the read/write mechanism (not shown) to write, on the storage medium 11, both the data encrypted in the re-encryption process and the re-encrypted data requested for by the write command coming from the host 20 (Block 311). Thus, data can be completely written on the storage medium 11, without delay, if the host 20 issues a write command during the re-encryption process.

If the host I/F 16 receives a read command from the host 20 (YES in Block 300), the controller 15 determines whether the buffer memory 13 stores the data that should be read (Block 301). At this point, the encryption module 17 is performing the re-encryption process, and the buffer memory 13 stores the data generated by decrypting the encrypted data read from the storage medium 11.

If the buffer memory 13 stores the decrypted data to be read in response to the read command, the controller 15 transmits the decrypted data via the host I/F 16 to the host 20 (Block 302). Thus, the decrypted data can be read, without delay, in response to the read command the host 20 has issued.

If the buffer memory 13 does not store the decrypted data to be read in response to the read command (NO in Block 301), the controller 15 interrupts the re-encryption process (Block 302). This is because the re-encryption process needs a long time, e.g., several hours, and priority should therefore be given to any read access request the host 20 makes. The re-encryption process should better be interrupted after the encryption module 17 decrypts the sector data as desired and the sector data decrypted is stored into the buffer memory 13.

After interrupting the re-encryption process, the controller 15 causes the read/write mechanism (not shown) to read data (encrypted data) as requested, from the storage medium (Block 304). Then, in the controller 15, the encryption module 17 decrypts the encrypted data read from the storage medium 11 (Block 305). At this point, the encryption module 17 uses the current encryption key or new encryption key set in the register 18, decrypting the data. The data thus decrypted is stored into the buffer memory 13. The host I/F 16 transmits the decrypted data (data read as requested) stored in the buffer memory 13 to the host 20 (Block 306).

After processing the read command so, the controller 15 starts the re-encryption process again, continuing the process until it is completed (Block 312). After the re-encryption process is started again, the data decrypted by using the current encryption key is stored in the buffer memory 13, as data to be read as requested. In this case, the encryption module 17 encrypts (re-encrypts) the decrypted data by using the new encryption key. The controller 15 causes the R/W channel 12 and read/write mechanism (not shown) to write the data back on the storage medium 11 (Block 304). If the data decrypted as data to be read as requested, by using the new encryption key, is stored in the buffer memory 13, the re-encryption process need not be performed to re-encrypt the data or to write the same on the storage medium (disk) 11.

As described above, the encryption key is updated at regular intervals in the data storage device 10 according to this embodiment, which has the function of encrypting data. All data recorded on the storage medium 11 can therefore re-encrypted. In this embodiment, the data is transferred between the storage medium 11 and the buffer memory 13 in the re-encryption process, unlike in the normal read/write mode (i.e., normal operating mode). To be more specific, the encryption module 17 uses the third input/output unit 173 and fourth input/output unit 174 as shown in FIG. 2, thereby receiving and outputting data during the re-encryption process. This reduces the overhead involving the data transfer between the encryption module 17 and the buffer memory 13, ultimately performing a smooth re-encryption process at high speed.

Moreover, if the host 20 makes a data access (i.e., read/write access) during the re-encryption process, issuing a write command to the controller 15, the write data transmitted from the host 20 can be duly received and stored into the buffer memory 13, without interrupting the re-encryption process. The write data thus stored into the buffer memory 13 is encrypted with the new encryption key in the re-encryption process, and is then stored on the storage medium 11. The host 20 may issue a read command during the re-encryption process. In this case, the controller 15 can transmit read data, if any, from the buffer memory 13 as requested, and transmit this data to the host 20, without interrupting the re-encryption process. Thus, the decrypted data to be read can be transmitted directly to the host 20, not through the encryption module 17.

Hence, the host 20 never waits for data coming from the controller 15 after making a data access, even if the encryption module 17 is busy performing the re-encryption process. If the buffer memory 13 stores the data that should be read, the re-encryption process is interrupted, and the data is read from the storage medium 11. That is, the data reading is performed prior to the re-encryption process. Also in this case, the host 20 need not wait for data coming from the controller 15 after making a data access.

In summary, the data storage device according to this embodiment performs the re-encryption process at high speed and efficiently processes commands during the re-encryption process, thus not only achieving high data security, but also preventing a decrease in operating efficiency.

In the embodiment, the re-encryption process is performed in response to the instructions coming from the MPU 14 (FW). Instead, the re-encryption process may be performed in response to the host 20. In the embodiment, the MPU 14 sets the encryption key or new encryption key in the register 18. Alternatively, the encryption module 17 may have the function of generating the encryption key or the new encryption key.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data storage device comprising:
an encryption controller configured to encrypt or decrypt data;
a storage medium configured to store encrypted data encrypted by the encryption controller;
an interface configured to transmit decrypted data decrypted by the encryption controller to a host;
a buffer memory configured to store the encrypted data or the decrypted data; and
a processor configured to:
store decrypted data in the buffer memory, the decrypted data being obtained by decrypting, by the encryption controller, encrypted data read from the storage medium;
cause the encryption controller to encrypt the decrypted data supplied from the buffer memory; and
store the encrypted data in the storage medium, for execution of a re-encryption process, wherein
the processor is configured to:
continue to execute the re-encryption process after receiving a write command from the host during the re-encryption process;
store write data designated by the write command into the buffer memory without encrypting by encryption controller;
store encrypted data obtained by encrypting the write data supplied from the buffer memory, by the encryption controller, in the storage medium;
continue to execute the re-encryption process if decrypted data correspond to read data designated by a read command is stored in the buffer memo when the read command is received during the re-encryption process; and
transmit the decrypted data is stored in the buffer memory without decrypting by the encryption controller to the host via the interface.

2. The data storage device of claim 1, wherein the processor is configured to interrupt the re-encryption process, if the decrypted data designated by the read command is not stored in the buffer memory when the read command is received during the re-encryption process, to decrypt the encrypted data read from the storage medium, after the re-encryption process has been interrupted, to store the decrypted data into the buffer memory, and to transmit the decrypted data from the buffer memory to the host via the interface.

3-20. (canceled)

21. The data storage device of claim 1, wherein the encryption controller comprises a first input/output device for inputting/outputting to/from the buffer memory during the re-encryption process and a second input/output device for inputting/outputting to/from the buffer memory,
wherein the processor is configured to:
cause the encryption controller to encrypt write data designated by a write command when the write command is received from the host during non-execution of the re-encryption process;
store the encrypted data obtained by encrypting the write data into the buffer memory via the second input/output device;
store the encrypted data in the storage medium from the buffer memory;
transfer the encrypted data in the buffer memory to the encryption controller via the second input/output device if the encrypted data correspond to data designated by a read command is stored in the buffer memory when the read command is received from the host during non-execution of the re-encryption process;
cause the encryption controller to decrypt the transferred the encrypted data; and
transmit the decrypted data as read data to the host via the interface.

22. The data storage device of claim 21,
wherein the processor is configured to:
interrupt the re-encryption process, if the decrypted data designated by the read command is not stored in the buffer memory when the read command is received during the re-encryption process;
decrypt the encrypted data read from the storage medium, after the re-encryption process has been interrupted;
store the decrypted data into the buffer memory; and
transmit the decrypted data from the buffer memory to the host via the first or the second input/output device.

23. The data storage device of claim 1,
wherein the processor is configured to:
decrypt the encoded data read from the storage medium by the encryption controller using an old encryption key set before the re-encryption process during the re-encryption process;
store the decrypted data in the buffer memory;
re-encrypt the decrypted data supplied from the buffer memory by the encryption controller using a new encryption key set for the re-encryption process;
store the re-encrypted data in the storage medium;
continue to execute the re-encryption process when the write command is received from the host during the re-encryption process;
store write data designated by the write command in the buffer memory without encrypting by the encryption controller;
encrypt the write data supplied from the buffer memory by the encryption controller using the new encryption key; and
store the encrypted data in the storage medium.

24. The data storage device of claim 21,
wherein the processor is configured to:
decrypt the encoded data read from the storage medium by the encryption controller using an old encryption key set before the re-encryption process during the re-encryption process;
store the decrypted data in the buffer memory;
re-encrypt the decrypted data supplied from the buffer memory by the encryption controller using a new encryption key set for the re-encryption process;
store the re-encrypted data in the storage medium;
continue to execute the re-encryption process when the write command is received from the host during the re-encryption process;
store write data designated by the write command in the buffer memory without encrypting by the encryption controller;
encrypt the write data supplied from the buffer memory by the encryption controller using the new encryption key; and
store the encrypted data in the storage medium.

25. A data control device applied to a data storage device and configured to control data transfer between a host and a storage medium, the data storage device comprising the storage medium for storing encrypted data and a buffer memory for storing the encrypted data or decrypted data, the data control device comprising:
an encryption controller configured to encrypt or decrypt data;
a host interface configured to transmit decrypted data obtained by the encryption controller to the host; and
a processor configured to store decrypted data in the buffer memory, the decrypted data being obtained by decrypting, by the encryption controller, encrypted data read from the storage medium, to cause the encryption controller to encrypt the decrypted data supplied from the buffer memory, and to store the encrypted data in the storage medium, for execution of a re-encryption process, wherein
the processor is configured to:
continue to execute the re-encryption process after receiving a write command from the host during the re-encryption process;
store write data designated by the write command into the buffer memory without encrypting by the encryption controller;
store encrypted data obtained by encrypting the write data supplied from the buffer memory, by the encryption controller, in the storage medium;
continue to execute the re-encryption process if decrypted data correspond to read data designated by a read command is stored in the buffer memory when the read command is received during the re-encryption process; and
transmit the decrypted data is stored in the buffer memory without decrypting by the encryption controller to the host via the interface.

26. The data control device of claim 25, wherein the encryption controller comprises a first input/output device for inputting/outputting to/from the buffer memory during the re-encryption process and a second input/output device for inputting/outputting to/from the buffer memory,
wherein the processor is configured to:
cause the encryption controller to encrypt write data designated by a write command when the write command is received from the host during non-execution of the re-encryption process;
store the encrypted data obtained by encrypting the write data into the buffer memory via the second input/output device;
store the encrypted data in the storage medium from the buffer memory;
transfer the encrypted data in the buffer memory to the encryption controller via the second input/output device if the encrypted data correspond to data designated by a read command is stored in the buffer memory when the read command is received from the host during non-execution of the re-encryption process;
cause the encryption controller to decrypt the transferred the encrypted data; and
transmit the decrypted data as read data to the host via the interface.

27. The data control device of claim 25,
wherein the processor is configured to:
interrupt the re-encryption process, if the decrypted data designated by the read command is not stored in the buffer memory when the read command is received during the re-encryption process;
decrypt the encrypted data read from the storage medium, after the re-encryption process has been interrupted;
store the decrypted data into the buffer memory; and
transmit the decrypted data from the buffer memory to the host via the first input/output device and the second input/output device.

28. The data control device of claim 26,
wherein the processor is configured to:
interrupt the re-encryption process, if the decrypted data designated by the read command is not stored in the buffer memory when the read command is received during the re-encryption process;
decrypt the encrypted data read from the storage medium, after the re-encryption process has been interrupted;
store the decrypted data into the buffer memory; and
transmit the decrypted data from the buffer memory to the host via the first or the second input/output device.

29. The data control device of claim 25,
wherein the processor is configured to:
decrypt the encoded data read from the storage medium by the encryption controller using an old encryption key set before the re-encryption process during the re-encryption process;
store the decrypted data in the buffer memory;
re-encrypt the decrypted data supplied from the buffer memory by the encryption controller using a new encryption key set for the re-encryption process;
store the re-encrypted data in the storage medium;
continue to execute the re-encryption process when the write command is received from the host during the re-encryption process;
store write data designated by the write command in the buffer memory without encrypting by the encryption controller;
encrypt the write data supplied from the buffer memory by the encryption controller using the new encryption key; and
store the encrypted data in the storage medium.

30. The data control device of claim 26,
wherein the processor is configured to:
decrypt the encoded data read from the storage medium by the encryption controller using an old encryption key set before the re-encryption process during the re-encryption process;
store the decrypted data in the buffer memory;
re-encrypt the decrypted data supplied from the buffer memory by the encryption controller using a new encryption key set for the re-encryption process;
store the re-encrypted data in the storage medium;
continue to execute the re-encryption process when the write command is received from the host during the re-encryption process;
store write data designated by the write command in the buffer memory without encrypting by the encryption controller;
encrypt the write data supplied from the buffer memory by the encryption controller using the new encryption key; and
store the encrypted data in the storage medium.

31. A method applied to a data storage device, the data storage device comprising a storage medium for storing encrypted data and a buffer memory for storing the encrypted data or decrypted data, the method comprising:
decrypting the encrypted data read from the storage medium in the buffer memory;
encrypting the decrypted data supplied from the buffer memory
storing the encrypted data in the storage medium, for execution of a re-encryption process;
continuing the re-encryption process after receiving a write command from a host during the re-encryption process;
storing write data designated by the write command into a buffer memory without encrypting;
storing encrypted data obtained by encrypting the write data supplied from the buffer memory, in the storage medium;
continuing the re-encryption process if decrypted data correspond to read data designated by a read command is stored in the buffer memory when the read command is received during the re-encryption process; and
transmitting the decrypted data is stored in the buffer memory without decrypting to the host via an interface.

32. The method of claim 31, wherein the data storage device further comprises an encryption controller, the encryption controller comprising a first input/output device for inputting/outputting to/from the buffer memory during the re-encryption process and a second input/output device for inputting/outputting to/from the buffer memory,
the method further comprising:
encrypting write data designated by a write command when the write command is received from the host during non-execution of the re-encryption process;
storing the encrypted data obtained by encrypting the write data into the buffer memory via the second input/output device;
storing the encrypted data in the storage medium from the buffer memory;
transferring the encrypted data in the buffer memory to an encryption controller via the second input/output device if the encrypted data correspond to data designated by a read command is stored in the buffer memory when the read command is received from the host during non-execution of the re-encryption process;
causing the encryption controller to decrypt the transferred the encrypted data; and
transmitting the decrypted data as read data to the host via the interface.

33. The method of claim 31, further comprising:
interrupting the re-encryption process, if the decrypted data designated by the read command is not stored in the buffer memory when the read command is received during the re-encryption process;
decrypting the encrypted data read from the storage medium, after the re-encryption process has been interrupted;
storing the decrypted data into the buffer memory; and
transmitting the decrypted data from the buffer memory to the host via the first input/output device.

34. The method of claim 32, further comprising:
interrupting the re-encryption process, if the decrypted data designated by the read command is not stored in the buffer memory when the read command is received during the re-encryption process;
decrypting the encrypted data read from the storage medium, after the re-encryption process has been interrupted;
storing the decrypted data into the buffer memory; and
transmitting the decrypted data from the buffer memory to the host via the first input/output device.

35. The method of claim 31, further comprising:
decrypting the encoded data read from the storage medium by the encryption controller using an old encryption key set before the re-encryption process during the re-encryption process;
storing the decrypted data in the buffer memory;
re-encrypting the decrypted data supplied from the buffer memory by the encryption controller using a new encryption key set for the re-encryption process;
storing the re-encrypted data in the storage medium;
continuing to execute the re-encryption process when the write command is received from the host during the re-encryption process;
storing write data designated by the write command in the buffer memory without encrypting by the encryption controller;
encrypting the write data supplied from the buffer memory by the encryption controller using the new encryption key; and
storing the encrypted data in the storage medium.

36. The method of claim 32, further comprising:
decrypting the encoded data read from the storage medium by the encryption controller using an old encryption key set before the re-encryption process during the re-encryption process;
storing the decrypted data in the buffer memory;
re-encrypting the decrypted data supplied from the buffer memory by the encryption controller using a new encryption key set for the re-encryption process;
storing the re-encrypted data in the storage medium;
continuing to execute the re-encryption process when the write command is received from the host during the re-encryption process;
storing write data designated by the write command in the buffer memory without encrypting by the encryption controller;
encrypting the write data supplied from the buffer memory by the encryption controller using the new encryption key; and
storing the encrypted data in the storage medium.
